(19) United States
(12) Patent Application Publication
(10) Pub. No.: US 2006/0098862 A1
(43) Pub. Date: May 11, 2006

(54) NANOSCALE DEFECT IMAGE DETECTION FOR SEMICONDUCTORS

(75) Inventors: James J. Demarest, Fishkill, NY (US); Kaushik Chanda, Fishkill, NY (US); Derren N. Dunn, Fishkill, NY (US); Yun-Yu Wang, Poughquag, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, ARMONK, NY (US)

(21) Appl. No.: 10/904,434

(22) Filed: Nov. 10, 2004

(51) Int. Cl. G06K 9/00

(52) U.S. Cl. 382/145

(57) ABSTRACT

Fail sites in a semiconductor are isolated through a difference image of a fail area and a healthy area. The fail area comprises an image of a semiconductor with a fail. The healthy area comprises an image of a semiconductor absent the fail or, in other words, an image of a semiconductor with healthy structure. Instructions cause a variation in the intensities of the difference image to appear at the fail site.

### FIELD OF THE INVENTION

The present invention relates generally to semiconductors, and more particularly to an enhanced method and system for fail site isolation and fail identification for semiconductors.

### BACKGROUND OF THE INVENTION

Identification of a fail within a semiconductor is problematic. Present day semiconductors are finely patterned, nanometer sized structures. Accordingly, isolation of a fail site and identification of a fail within the isolated fail area is often impossible with prior art methods. Isolation of the fail site and identification of a fail will become increasingly more difficult as semiconductor dimensionality diminishes. In addition, low-k dielectrics (k less than about 4) have novel material properties, which also complicates isolation of the fail. The adverse affect of low-k dielectrics is particularly apparent with use of focused ion beam (“FIB”) voltage contrast techniques because ion beam/sample interactions introduce conductive pathways, which undermine the physics exploited by the FIB method.

Prior art methods isolate the defect to an area approximately 100 μm² variation depicted in FIG. 3 in accordance with the present invention μm² large. Some prior art defect isolation methods include, but are not limited to, optical inspection, optical/electrical defect isolation techniques such as liquid crystal, light-induced voltage alteration (“LIVA”), thermally induced voltage alterations (“TIVA”), optical beam induced current (“OBIC”), and optical beam induced resistivity change (“OBIRCH”), voltage contrast performed in a FIB or scanning electron microscope (“SEM”), and SEM inspection. Some prior art imaging methods include, but are not limited to, optical microscopy, scanning electron microscopy (“SEM”), transmission electron microscopy (“TEM”), scanning transmission electron microscopy (“STEM”), and focused ion beam (“FIB”) microscopy.

FIG. 1 illustrates the prior art. FIG. 1 represents a 100 μm² image of a healthy area 100 confined through prior art imaging methods, such as but not limited to, SEM, TEM, STEM, and FIB imaging. SEM imaging includes, but is not limited to, secondary electron imaging, backscattered electron imaging, and Auger mapping imaging. TEM imaging includes, but is not limited to, bright field, dark field, and z-contrast imaging. STEM imaging includes, but is not limited to, bright field, dark field, and high angle dark field imaging. FIB imaging includes, but is not limited to, ion and electron imaging. The healthy area 100 in a semiconductor is an area absent the presence of a fail. The intensities in the healthy area 100 comprise charged particle counts at pixel locations. Multiple dummy tungsten contacts 102, low-k dielectric between the copper lines 104, and copper lines 106 are depicted. Often, the image of the healthy area 100 is directly adjacent the defect area, but such arrangement is not required by the present invention. Ideally, the image of the healthy area 100 should be acquired under imaging conditions as nearly identical to those used to obtain the image of the defect area.

FIG. 2 also depicts the prior art. More specifically, FIG. 2 represents a defect area 200 approximately 100 μm² large on a semiconductor. Through prior art imaging methods, such as, but not limited to, SEM, TEM, STEM, and FIB imaging, the defect area 200 has been confined to within the boundaries of the 100 μm², however prior art imaging methods cannot identify the location of the fail any more specifically. The present invention is compatible with, but is not limited to, the use of secondary electron, backscattered, transmission electron, ion beam, and a scanning transmission electron images.

With continued reference to both FIGS. 1 and 2, both represent a 100 μm² area isolated using prior art methods. The intensities found in FIG. 2 appear visually identical to the intensities in FIG. 1. Accordingly, the juxtaposition of FIGS. 1 and 2 highlights the problem associated with prior art methods. Prior art methods do not easily unearth the fail. Often, the fail is subsurface, i.e. greater than or equal to 1 Angstrom beneath the semiconductor surface, and not readily identifiable using prior art methods, which further complicates prior art fail isolation.

As demonstrated by FIGS. 1 and 2, prior art methods isolate subtle semiconductor defects with tremendous difficulty. Even with optical and SEM microscopy assistance, visibility of the fail within nanometer sized semiconductor structures is difficult. Prior art methods have some success with identification of surface defects, but have little success refining the isolated area within this 100 μm² region. Isolation of the fail site to an area less than 100 μm² large would narrow the scope of the fail search but such is not possible with most prior art methods. Instead, most prior art methods confine the defect to an area 100 μm² large. Typically top down SEM inspection is then performed followed by multiple cross sectional images taken randomly or methodically, but certainly, repeatedly until the fail has been identified. An analyst could spend 2-6 hours or more examining the multiple cross sectional images. For at least these reasons, prior art methods deficiently isolate the fail site and identify the fail.

Other prior art problems are unique to the imaging method employed. TEM and STEM, for example, require a thin semiconductor specimen (less than about 0.2 μm thick). Consequently, precise knowledge about the defect location is necessary prior to sample preparation for these methods. With respect to FIB, new dielectric materials are being incorporated into semiconductors that, as described above, adversely interact with the ion beams of the FIB, thereby preventing identification of the fail. For these further reasons, prior art methods deficiently isolate the fail site and do not readily identify the fail.

These and other deficiencies in the prior art are overcome through the present invention.

Therefore, there remains a need in the art for an improved method and system for isolation of the fail site and identification of the fail within that fail site for semiconductors.

### BRIEF SUMMARY OF THE INVENTION

The present invention is directed to a method for identification of a fail site in a semiconductor. According to the present invention, a difference image is generated with intensities representative of a difference between an image of a fail area and a healthy area. The present invention then receives an instruction to cause a variation in the intensities of the difference image to appear at a location in the difference image. Finally, the present invention identifies the fail site as the location of the variation in the difference image.

The present invention is further directed to a system for identifying a location of a fail site in a semiconductor. The present invention comprises a difference image generating device and an input device. The difference image generating device generates a difference image with intensities representative of a difference between an image of a healthy area and a defect area. The input device enables entry of an instruction that causes a variation in the intensities of the difference image to appear at a location in the difference image representative of the location of the fail site in the semiconductor. Additionally, the present invention may comprise an output device for presenting the difference image with the variation.

The present invention saves costs, improves realization time and yield, and increases fabrication efficiency and productivity, which in turn may result in increased profits. The present invention narrows the scope of the fail search. Accordingly, the present invention improves realization time for fail identification. The present invention identifies both subsurface fails and subtle fails that do not immediately fail, but instead fail upon subsequent exercise. Accordingly, the present invention improves semiconductor reliability. Finally, the present invention improves semiconductor fabrication efficiency and productivity because the cause of the fail can be more quickly identified and corrected. Such improvements in fail site isolation and fail identification within that isolated fail site can result in increased profits to organizations employing the methods and system of present invention.

For at least the foregoing reasons, the present invention improves upon fail site isolation and fail identification for semiconductors.

### BRIEF DESCRIPTION OF THE FIGURES

The features and the element characteristics of the invention are set forth with particularity in the appended claims. The figures are for illustrative purposes only and are not drawn to scale. Furthermore, like numbers represent like features in the drawings. The invention itself, however, both as to organization and method of operation, may best be understood by reference to the detailed description which follows, taken in conjunction with the accompanying figures, in which:

FIG. 1 illustrates an image of an area that is absent a fail in a semiconductor in accordance with the prior art;

FIG. 2 illustrates an image of an area comprising a fail in the semiconductor of FIG. 1 in accordance with the prior art;

FIG. 3 illustrates a difference image of the images of FIGS. 1 and 2 with an intensity variation that appears at a location of the fail for the semiconductor depicted in FIGS. 1-2 in accordance with the present invention;

FIG. 4 illustrates a low magnification cross sectional TEM image of the fail site that appears at the intensity variation depicted in FIG. 3 in accordance with the present invention; and,

FIG. 5 illustrates a high magnification cross sectional TEM image of the fail site that appears at the intensity variation depicted in FIG. 3 in accordance with the present invention.

### DETAILED DESCRIPTION OF THE PREFERRED EMBODIMENTS

The invention will now be described with reference to the accompanying figures. In the figures, various aspects of the structures have been shown and schematically represented in a simplified manner to more clearly describe and illustrate the invention.

The present invention generates a difference image with intensities representative of a difference between an image of a 100 μm² large area on a semiconductor comprising a fail and a 100 μm² area on the semiconductor with healthy structure, or in other words, absent the presence of the fail. Following generation of the difference image, the present invention receives instructions that cause a variation in the intensities of the difference image. The instructions include, but are not limited to, instructions to manipulate the intensities through one of a brightness, contrast, gamma, thresholding, and levels manipulation of the difference image. Those skilled in the art know that such instructions are available through commercially available software packages such as, but not limited to, Adobe Photoshop. Once the variation is caused, the present invention associates the location of the variation with the location of the fail site in the semiconductor. Upon isolation of the fail site, cross sectional images of the fail site will be further taken in an effort to identify the fail and determine its cause.

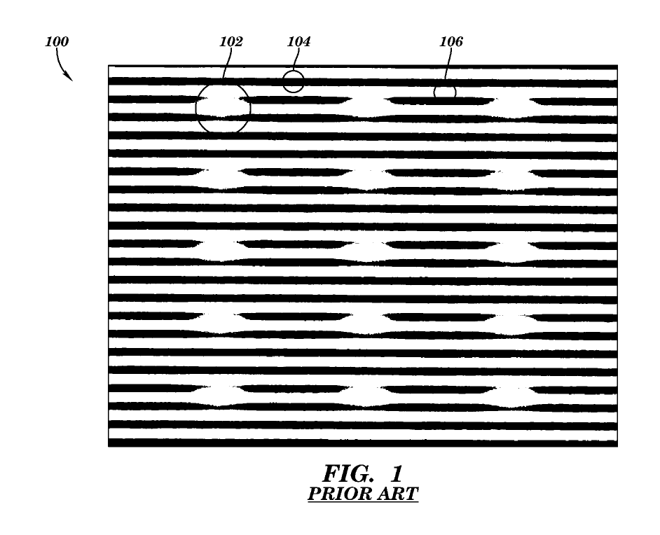

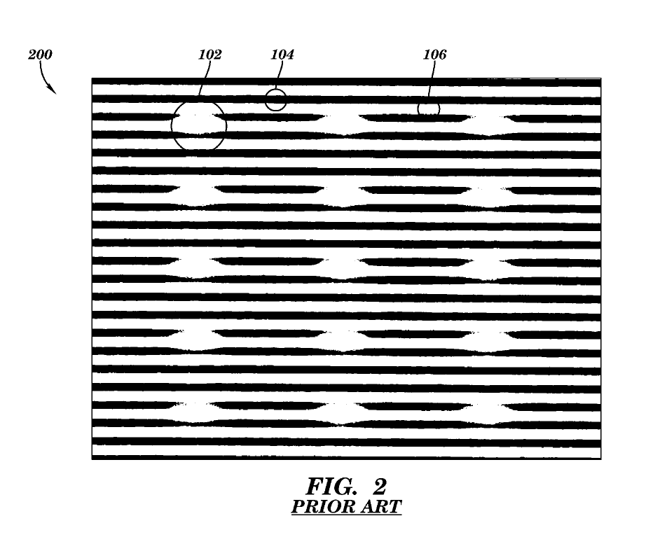

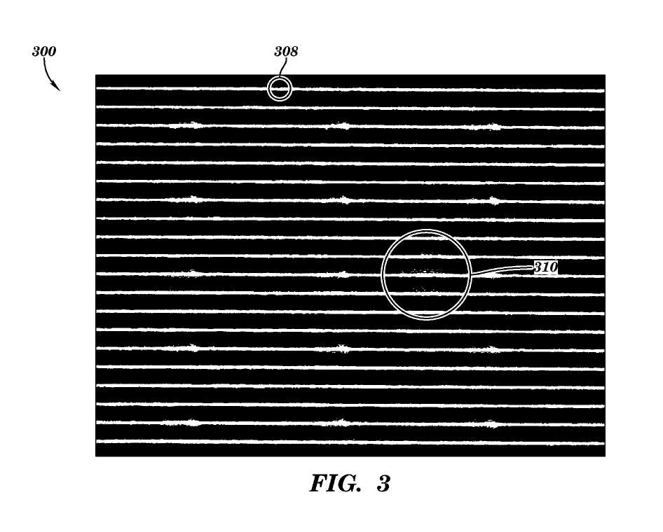

FIG. 3 illustrates a difference image 300 of the healthy area 100 and the defect area 200 with an intensity variation that appears at the fail site 310 of the semiconductor in accordance with the present invention. As shown in FIG. 3, the difference image depicts an intensity difference 308 caused by any misalignment of FIGS. 1 and 2. A user enters an instruction that causes a variation in the intensities through the use of an input device. The present invention receives the instruction to cause a variation in the intensities of the difference image 300 to appear on an output device. The intensities of the difference image 300 illustrated in FIG. 3 appear primarily as lines on a black backdrop. If FIGS. 1 and 2 were perfectly aligned and identical in all respects, no lines would appear, and would be uniformly black (zero intensity) because the intensities would cancel each other out in the difference image 300. Because the present invention receives instructions to cause a variation in the intensities, a variation appears at a location in the difference image 300 in response to the received instructions. The instructions manipulate the intensities of the difference image 300. Some such instructions, include but are not limited to, manipulation of the difference image intensities through brightness, contrast, gamma, thresholding, and levels manipulation. Such variation highlights the difference, caused by the presence of the fail, between the defect area 200 and the healthy area 100 that prior to the received instructions were visually indiscernible.

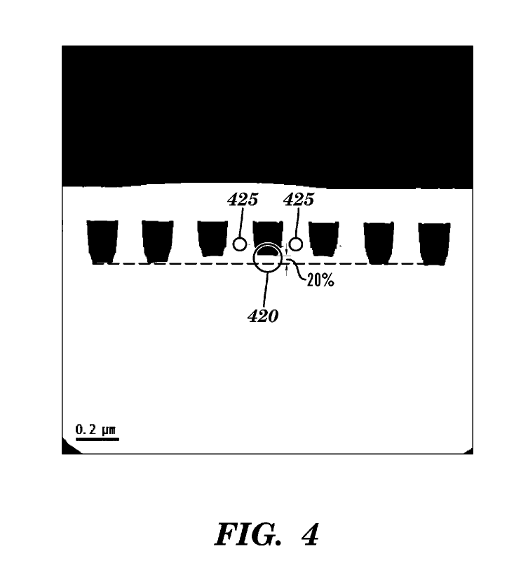

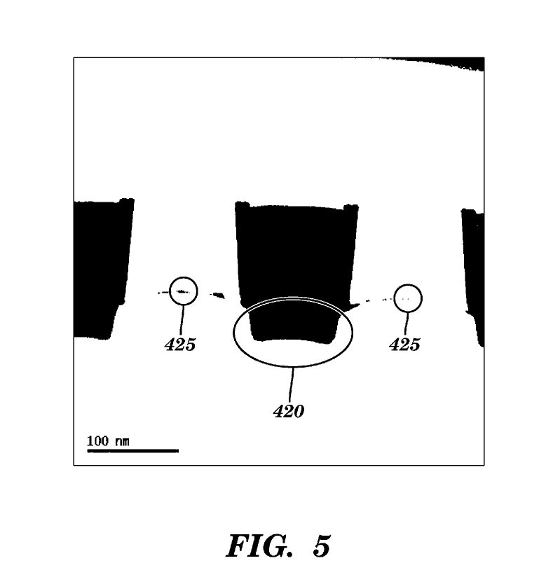

FIGS. 4 and 5 illustrate cross sectional images of the fail site 310. Cross sectional images of the fail site 310 are taken to identify the fail and its cause. FIG. 4 represents a cross sectional area about 0.2 μm thick of the fail site 310, while FIG. 5 represents a further magnification TEM image of the fail site 310. Through examination of the fail site 310, the present invention enables the determination of the cause of the fail. More specifically, FIG. 4 depicts an approximate twenty percent reduction in copper line height. Such reduction in copper line height was the result of the fail 420 mechanism. Upon further magnification, as illustrated in FIG. 5, other defect details become visible. As shown in FIG. 5, a thin layer of contamination 425 is located between the interconnect and the dielectric material, which was the root cause of the fail.

In sum, the present invention enables precise fail identification and comprehension of the cause of the fail.

While the present invention has been particularly described in conjunction with a specific preferred embodiment and other alternative embodiments, it is evident that numerous alternatives, modifications and variations will be apparent to those skilled in the art in light of the foregoing description. It is therefore intended that the appended claims embrace all such alternatives, modifications and variations as falling within the true scope and spirit of the present invention.

What is claimed is:

1. A method for identification of a fail site in a semiconductor, comprising, the steps of:
(a) generating a difference image with intensities representative of a difference between an image of a healthy area and a defect area;
(b) receiving an instruction to cause a variation in said intensities of said difference image to appear at a location in said difference image; and,
(c) identifying said location of said variation in said difference image as a location of said fail site in said semiconductor.

2. A method as in claim 1, wherein a fail in said fail site is one of subsurface and not readily visible through one of SEM, TEM, STEM, FIB imaging, and optical inspection.

3. A method as in claim 2, wherein said SEM imaging comprises one of secondary electron imaging, backscattered electron imaging, and Auger mapping imaging, said TEM imaging comprises one of said bright field, dark field, and z-contrast imaging, said STEM imaging comprises one of bright field, dark field, and high angle dark field imaging, and said FIB imaging comprises one of ion and electron imaging.

4. A method as in claim 1, wherein said images comprise one of a secondary electron image, a backscattered electron image, a transmission electron image, an ion beam image, and a scanning transmission electron image.

5. A method as in claim 1, wherein said intensities comprise a charged particle count at pixel locations.

6. A method as in claim 1, wherein said defect area comprises an image of said semiconductor with a fail.

7. A method as in claim 1, wherein said areas comprise an area of about less than or equal to 100 μm².

8. A method as in claim 1, wherein said healthy area comprises an image of said semiconductor absent said fail.

9. A method as in claim 1, wherein said healthy area is adjacent said fail area.

10. A method as in claim 1, wherein said instruction in step (b) manipulates said intensities of said difference image through one of a brightness, a contrast, a gamma, a thresholding, and a levels manipulation of said difference image.

11. A method as in claim 10, wherein said variation appears through visual inspection of said difference image.

12. A method as in claim 1, further comprising, the step of:
(d) imaging said fail site in cross section.

13. A method as in claim 12, further comprising, the step of:
(e) identifying said fail in said cross sectional image of said fail site.

14. A system for identifying a location of a fail site in a semiconductor, comprising:
a device for generating a difference image with intensities representative of a difference between an image of a healthy area and a defect area; and,
an input device for entering an instruction that causes a variation in said intensities of said difference image to appear at a location in said difference image representative of said location of said fail site in said semiconductor.

15. A system as in claim 14, further comprising:
an output device for presenting said difference image with said variation.

16. A system as in claim 14, wherein said fail is one of subsurface and not readily visible through one of SEM, TEM, STEM, FIB imaging, optical inspection, and resistive heating.

17. A system as in claim 16, wherein said SEM imaging comprises one of secondary electron imaging, backscattered electron imaging, and Auger mapping imaging, said TEM imaging comprises one of said bright field, dark field, and z-contrast imaging, said STEM imaging comprises one of bright field, dark field, and high angle dark field imaging, and said FIB imaging comprises one of ion and electron imaging.

18. A system as in claim 14, wherein said difference image comprises one of a secondary electron image, a backscattered electron image, a transmission electron image, an ion beam image, and a scanning transmission electron image.

19. A system as in claim 14, wherein said intensities comprise a charged particle count at pixel locations.

20. A system as in claim 14, wherein said defect area comprises an image of said semiconductor with a fail.

21. A system as in claim 14, wherein said areas comprise an area of about less than or equal to 100 μm².

22. A system as in claim 14, wherein said healthy area comprises an image of said semiconductor absent said fail.

23. A system as in claim 14, wherein said healthy area is adjacent said fail area.

24. A system as in claim 14, wherein said instruction manipulates said intensities of said difference image through one of a brightness, a contrast, a gamma, a thresholding, and a levels manipulation of said difference image.

25. A system as in claim 14, wherein said variation appears through visual inspection of said difference image.

26. A system as in claim 1 5, further comprising:
a device for imaging a cross sectional area of said fail site.

27. A computer-readable storage medium having stored instructions for performing a method, the method comprising the steps of:
(a) generating a difference image with intensities representative of a difference between an image of a healthy area and a defect area;
(b) receiving an instruction to cause a variation in said intensities of said difference image to appear at a location in said difference image; and,
(c) identifying said location of said variation in said difference image as a location of said fail site in said semiconductor.

28. A method for deploying infrastructure, comprising integrating computer readable code into a computing system, wherein the code in combination with the computing system is capable of performing:
(a) generating a difference image with intensities representative of a difference between an image of a healthy area and a defect area;
(b) receiving an instruction to cause a variation in said intensities of said difference image to appear at a location in said difference image; and,
(c) identifying said location of said variation in said difference image as a location of said fail site in said semiconductor.

29. A method as in claim 28, further comprising, the step of:
(d) imaging said fail site in cross section.

30. A method as in claim 29, further comprising, the step of:
(e) identifying said fail in said cross sectional image of said fail site.
